(19) United States
(12) Patent Application Publication
(10) Pub. No.: US 2009/0197653 A1
(43) Pub. Date: Aug. 6, 2009

(54) MOBILE APPARATUS

(75) Inventors: Satoshi Mizoguch, Tokyo (JP); Naoto Ito, Tokyo (JP); Hiroshi Shimasaki, Tokyo (JP); Satoru Hara, Yokohama-shi (JP); Takahiro Sogou, Yokohama-shi (JP); Taizo Tomioka, Yokohama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/269,399

(22) Filed: Nov. 12, 2008

(30) Foreign Application Priority Data
Jan. 31, 2008 (JP) P2008-021983

(51) Int. Cl. H04M 1/02; A45F 5/00

(52) U.S. Cl. 455/575.7; 224/191

(57) ABSTRACT

According one aspect of the invention, there is provided a mobile apparatus including: a main face; a back face opposite to the main face, the back face being printed with visible user information; a thickness from the main face to the back face; an antenna disposed at a position nearer the back face than the main face; and an attachment portion attachable with a wearing tool, the wearing tool allowing a user to wear the mobile apparatus.

The entire disclosure of Japanese Patent Application No. 2008-021983 filed on Jan. 31, 2008, including specification, claims, drawings and abstract is incorporated herein by reference in its entirety.

### BACKGROUND

1. Field of the Invention

One aspect of the present invention relates to a thin-sized mobile apparatus, and more particularly, to arrangement of an antenna and the like.

2. Description of the Related Art

As a type of mobile phone, there is a thin-sized mobile phone. Since the mobile phone is than, the mobile phone may be used closer to a human body. In this case, it is necessary to examine the optimal arrangement of an antenna, in consideration of the effect of the human body on performance of the antenna.

It is well known that a human body deteriorates performance of an antenna. There is a mobile wireless terminal studied in consideration of such an effect (see JPA-2005-354501 (page 1, page 5, FIG. 1, and FIG. 2, for instance). The mobile wireless terminal is formed in a chest pocket type and has a flat side A and an uneven side B, and the antenna is disposed on the side B. A user puts the mobile wireless terminal in the chest pocket unconsciously to have the flat side A facing a user's body, and thus an antenna on the side B is away from the user's body, thereby securing performance of the antenna.

A non-contact type IC card such as an employee identification card has been well known (see JP-A-11-328348 (page 1 and FIG. 1)). Such an IC card has a printed face for identifying an employee with eyes and has an antenna for a non-contact IC therein.

In JP-A-2005-354501, a configuration for putting the mobile wireless terminal in a chest pocket is described, but there is no description of arrangement of an antenna in a case of using the mobile wireless terminal with a neck strap hanging on a neck. In JP-A-11-328348, there is no description of antenna communication in a state where an IC card hung on a neck with a neck strap close to a human body, and a user performs communication for non-contact IC generally in a state where the IC card is put close to an external reader/writer device. The IC card does not have a function of a mobile phone, and there is no description about a phone communicating antenna.

### SUMMARY

According to one aspect of the invention, there is provided a mobile apparatus including: a main face; a back face opposite to the main face, the back face being printed with visible user information; a thickness from the main face to the back face; an antenna disposed at a position nearer the back face than the main face; and an attachment portion attachable with a wearing tool, the wearing tool, allowing a user to wear the mobile apparatus.

### BRIEF DESCRIPTION OF THE DRAWINGS

Embodiment may be described in detail with reference to the accompanying drawings, in which:

FIGS. 1A to 1D are exemplary views illustrating an appearance of a mobile apparatus according to a first Embodiment, a second Embodiment, and a third Embodiment of the invention;

FIGS. 2A to 2C are exemplary views illustrating how a user wears the mobile apparatus according to the first to the third Embodiments;

FIGS. 3A to 3D are exemplary partially transparent views illustrating arrangement of antennas of the mobile apparatus according to the first Embodiment;

FIGS. 4A to 4C are exemplary partially transparent views illustrating arrangement of antennas of the mobile apparatus according to the first Embodiment;

FIGS. 5A and 5B are exemplary partially transparent views illustrating an arrangement of antennas of the mobile apparatus according to the second Embodiment; and

FIGS. 6A to 6D are exemplary partially transparent views illustrating an arrangement of antennas of the mobile apparatus according to the third Embodiment.

### DETAILED DESCRIPTION OF THE EMBODIMENTS

Hereinafter, embodiments of the invention will be described with reference to the drawings.

### First Embodiment

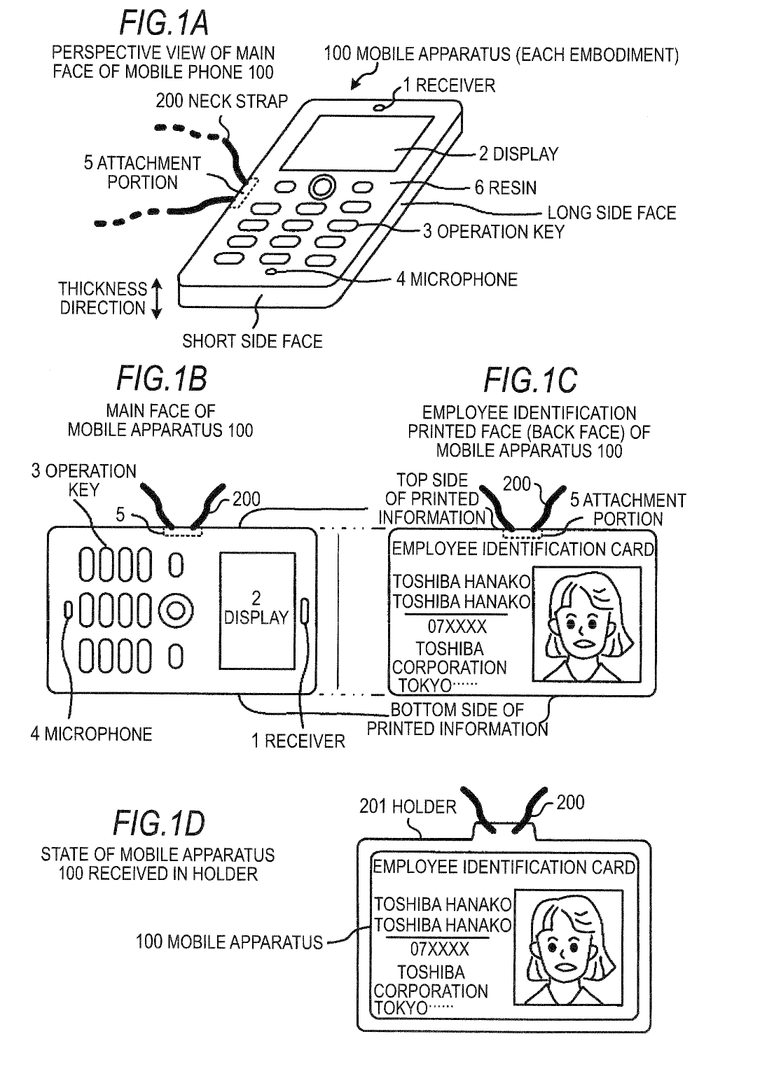

FIGS. 1A to 1D are views illustrating an appearance of a mobile apparatus according to a first Embodiment, a second Embodiment, and a third Embodiment of the invention, in which FIG. 1A is a perspective view illustrating a main face. FIG. 1B is a plan view illustrating the main face, FIG. 1C is a plan view illustrating a back face, and FIG. 1D is a plan view illustrating a back face with the mobile apparatus housed in a holder. A mobile apparatus 100 has a substantially rectangular shape formed of long sides and short sides, and is formed of a card type having a thickness from the back face to the main face.

In FIG. 1A and FIG. 1B, a user interface such as a receiver 1, a display 2, a plurality of operation keys 3, a microphone 4 as a transmitter is provided on the main face of the mobile apparatus, from one short side to the other short side, that is, in a length direction in order, which is a longitudinal arrangement of a general mobile apparatus. An attachment portion 5 is provided on one long side. The mobile apparatus is generally shaped by resin 6 surrounding the components and to show surfaces thereof.

In FIG. 1C, visible user information such as an employee identification is printed on the back face of the mobile apparatus 100. The user information is printed to be visible in a transverse direction of the rectangular shape. The attachment portion 5 is provided on the top of the printed user information, that is, the top of characters or a photograph. A neck strap 200 is attached to the attachment portion 5, so that the top of the user information is upward and the back face is outward. The mobile apparatus 100 is hung down on a user's neck, so that the user information can be shown to the other people.

As described above, the user interface provided on the main face is arranged longitudinally as the general mobile apparatus, and thus the operation of the mobile phone is easy. The visible user information printed on the back face is arranged transversely, and thus it is easy to see the user information.

In FIG. 1D, the mobile apparatus 100 is put into a holder 201, a neck strap 200 attached to the holder 201 is hung on the user's neck. The holder 201 is formed of a window or transparent type to show the back face of the mobile phone 100, and a type having a window to operate the main face of the mobile apparatus 100. The mobile apparatus 100 may not be provided with the attachment portion 5 for attaching the neck strap 200.

The neck strap 200 may be replaced by a clip (not show) attached to the holder 201, and anything may be used as long as the top of the user information is upward and the back face is outward.

As described above, if the printed face is kept to be disposed on the opposite side to a human body, the printed face is visible to the other people anytime. To do so, a holder may be used, or the mobile phone may be fixed to easily show the printed face to the other people by the other means.

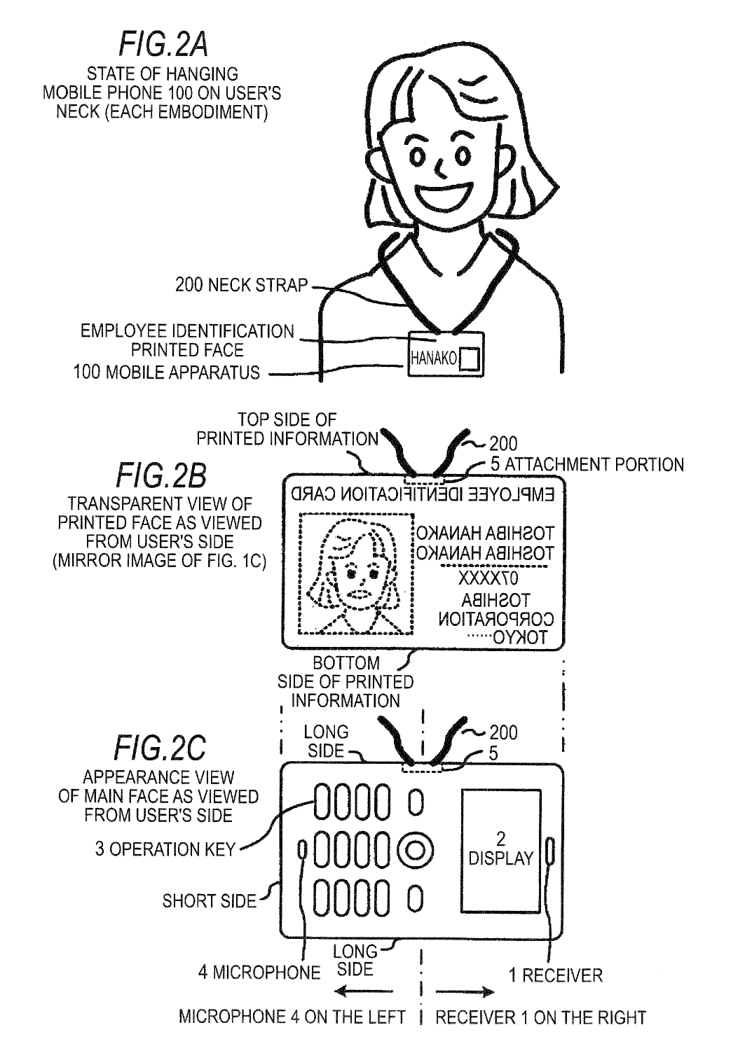

FIGS. 2A to 2C are views illustrating how a user wears the mobile apparatus according to the first Embodiment to the third Embodiment. FIG. 2A is a view illustrating a state of hanging the mobile apparatus on a neck, FIG. 2B is a transparent view illustrating the printed face of the mobile apparatus as viewed from the user side, and FIG. 2C is a view illustrating appearance of the main face of the mobile apparatus as viewed from the user side.

FIG. 2A is a view illustrating a state of hanging the mobile apparatus on a neck. A user who is a possessor of the mobile apparatus 100 wears the mobile apparatus 100 to consciously make the employee identification printed face outward, since the other people identifies the possessor of the mobile apparatus 100 with the eyes by the employee identification printed face (back face) of the mobile apparatus 100.

FIG. 2B is a transparent view illustrating the printed face of the mobile apparatus as viewed from the user side, and is a mirror image of FIG. 1C. FIG. 2C is a view illustrating appearance of the main face of the mobile apparatus as viewed from the user side.

On the main face of the mobile apparatus 100, the receiver 1 is provided on the right side from the top to the bottom of the user information, and the microphone 4 is provided on the left side.

In the hanging state, to use a phone function of the mobile apparatus 100, when a user catches the long side of the mobile apparatus 100 with a user's left hand and takes it to a user's left ear, the receiver 1 approaches the user's ear and the microphone 4 approaches a user's mouth. When the user holds the mobile apparatus 100 with the left hand and takes it to user's eyes, the display 2 is disposed on the upside, and the operation keys 3 are disposed on the downside, thereby easily operating the mobile apparatus 100.

For a case where the user catches the long side of the mobile apparatus 100 with the user's right hand and takes it to the right ear, the receiver 1 and the microphone 4 may be provided reversely. In addition, the display and the operation keys 3 may be provided reversely.

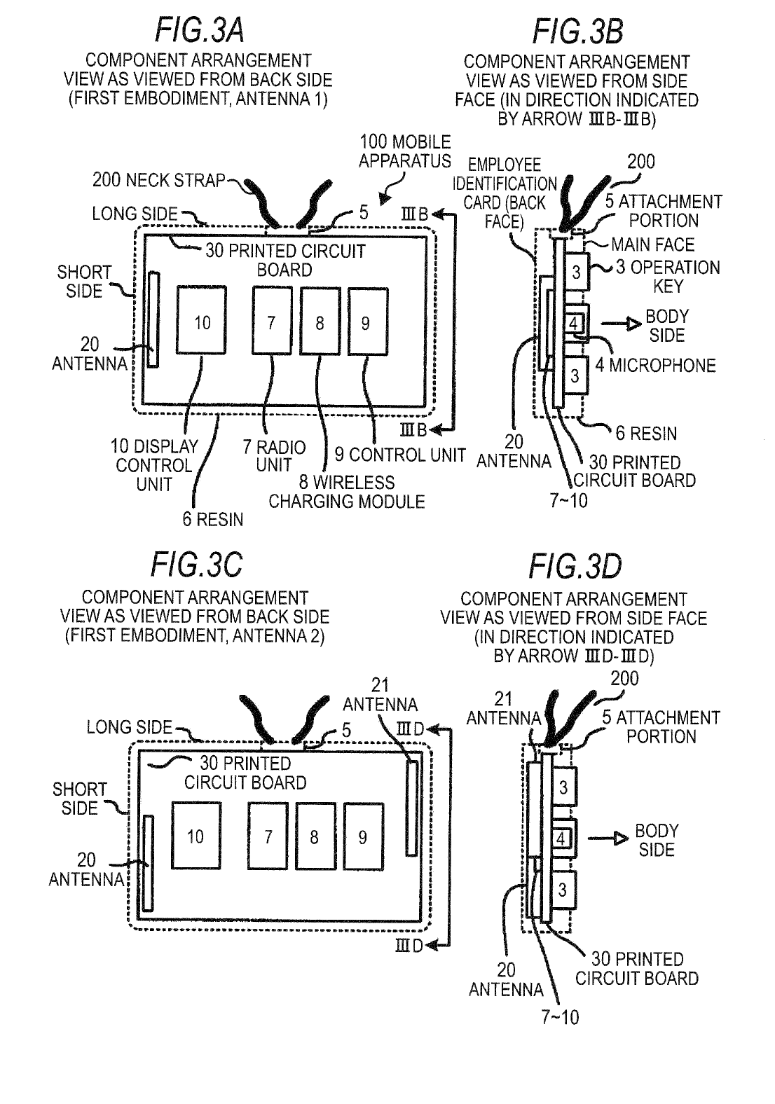

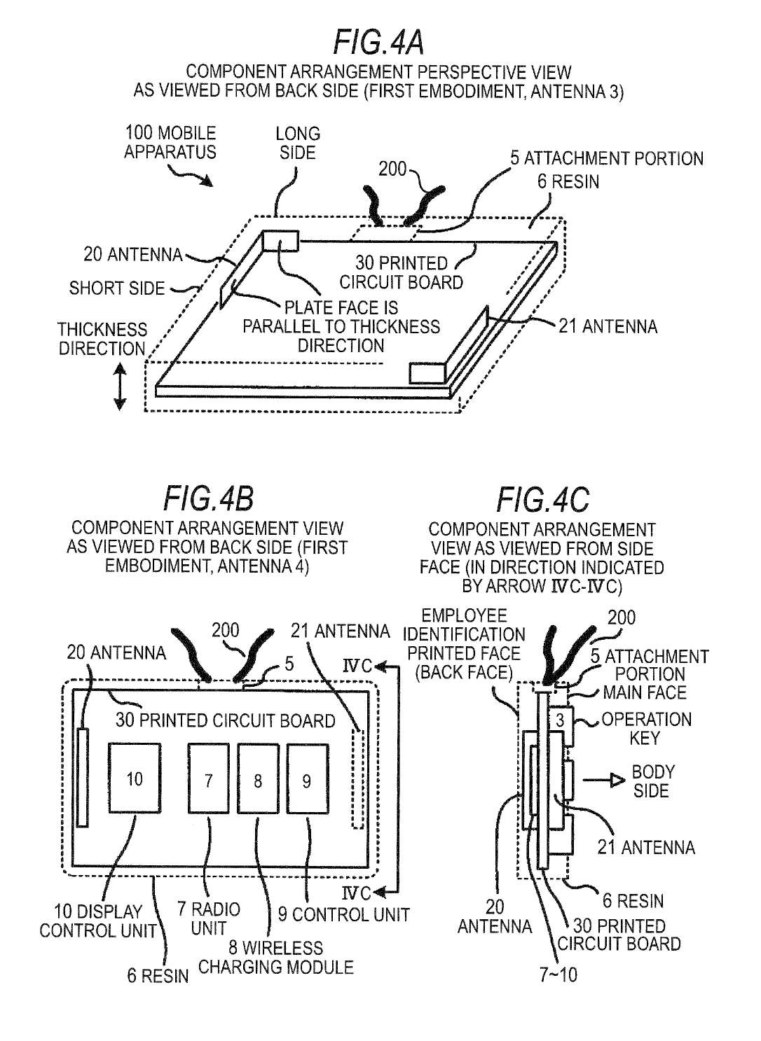

FIGS. 3A to 4C are partially transparent component arrangement views illustrating antenna arrangement of the mobile apparatus according to the first Embodiment. FIG. 3A and FIG. 3B show Antenna 1, FIG. 3C and FIG. 3D show Antenna 2, FIG. 4A shows Antenna 3, and FIG. 4B and FIG. 4C show Antenna 4.

(Antenna 1)

FIG. 3A is a component arrangement view as viewed from the back face side in a partial transparent state. FIG. 3B is a component arrangement view illustrating the side of FIG. 3A as viewed in a direction indicated by Arrow IIIB-IIIB in a partial transparent state. A printed circuit board 30 is provided in the mobile apparatus 100 hardened by the resin 6. A radio unit 7, a wireless charging module 8, a control unit 9, an antenna 20, and the like are mounted on the back face of the printed circuit board 30. The user interface such as the operation keys 3, the microphone 4, and the like is mounted on the main face of the printed circuit board 30, and the surface of the user interface is shown from the outside of the resin 6.

The wireless charging module 8 is a power supply unit charged by non-contact electromagnetic induction from a charger-provided outside the mobile apparatus 100, and supplies power to the whole mobile apparatus 100.

When a user hangs the mobile apparatus 100 on the user's own neck with the neck, strap 200, the user consciously makes the employ identification printed face (back face) outward and makes the main face be toward the human body. Accordingly, the antenna 20 is away from the human body, thereby preventing deterioration in performance of the antenna.

(Antenna 2)

In FIG. 3C and FIG. 3D, an antenna 20 and an antenna 21 are provided as the antenna. As described in Antenna 1, the antennas 20 and 21 are mounted on the back face of the printed circuit board 30. The antenna 20 and the antenna 21 are provided in the vicinity of the short sides of the back face away from each other on a diagonal line, to prevent interference between both antennas. Both antennas may be used, for example, as diversity antennas or the like.

Also in Antenna 2, the antennas are away from the human body, thereby preventing deterioration in performance of the antennas, as described in Antenna 1.

(Antenna 3)

In FIG. 4A, the antenna 20 and the antenna 21 are L-shaped plates, faces of which are parallel to the thickness direction of the mobile apparatus 100. The antenna 20 and the antenna 21 are mounted on the back face of the printed circuit board 30 in the vicinity of the corner between the long side and the short side.

According to such a configuration, there is the same effect as Antenna 1 and Antenna 2, and it is possible to improve rigidity of the mobile apparatus 100 against bending.

(Antenna 4)

In FIG. 4B and FIG. 4C, the antenna 20 is provided on the back face of the printed circuit board 30, and the antenna 21 is provided on the main face of the printed circuit board 30. When a user hangs the mobile apparatus 100 on the user's own neck with the neck strap 200, the user consciously makes the employee identification printed face (back face) outward. However, the neck strap 2 00 may be twisted by moving or shaking of the human body and thus the employee identification printed face (back face) may be toward the human body.

Even when any one of the employee identification printed face (back face) and the main face is toward the human body, any one of the antenna 20 and the antenna 21 is always outward away from the human body. Accordingly, it is prevent deterioration in performance of the antenna against the twist of the neck strap 200.

### Second Embodiment

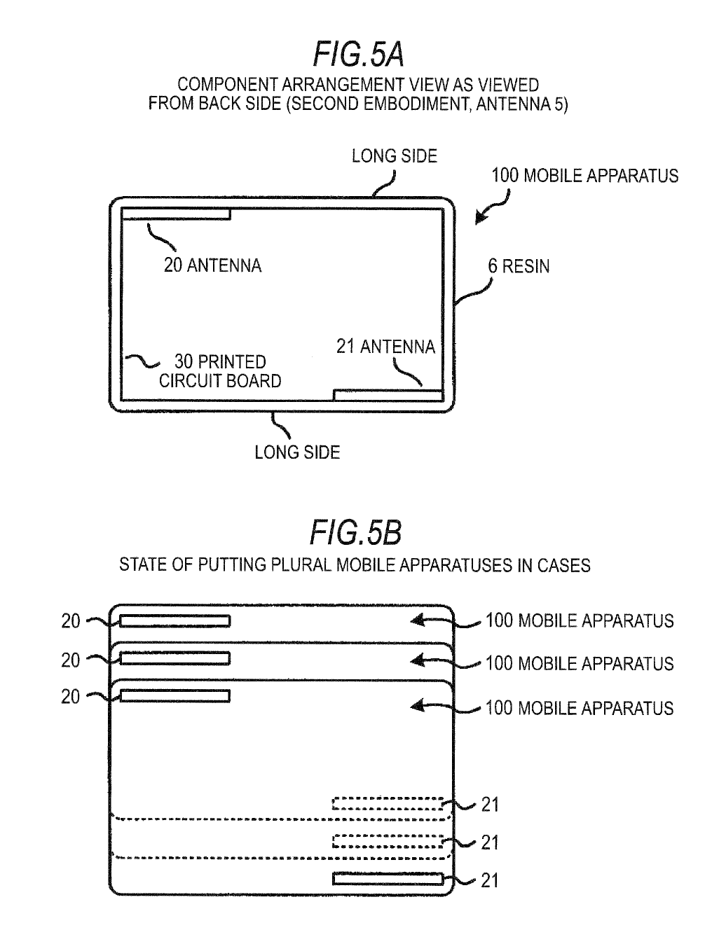

FIGS. 5A and 5B are a partially transparent component arrangement view illustrating antenna arrangement of the mobile apparatus according to the second Embodiment. FIG. 5A shows Antenna 5, FIG. 5B shows a state of inserting a plurality of mobile apparatuses 100 in cases. FIGS. 1A to 2C are common with the first Embodiment, and the description thereof is omitted.

As shown in FIG. 5A, the antenna 20 and the antenna 21 are mounted in the vicinity of the long sides on the back face of the printed circuit board 30. As shown in FIG. 5B, when the plurality of mobile apparatuses 100 are inserted to a plurality of cases for mobile apparatuses, the antennas 20 of the mobile apparatuses 100 do not overlap with each other. In addition, the antennas 21 do not overlap with each other. Only any one of the antenna 20 and the antenna 21 may be provided.

In the second Embodiment, when the mobile phone 100 is put on the human body, the antenna 20 and the antenna 21 are away from the human body, as described in Embodiment 1. Accordingly, it is possible to prevent deterioration in performance of the antennas. In addition, even when the plurality of mobile apparatuses 100 are inserted to the cases, it is possible to prevent deterioration in performance of the antennas 100.

### Third Embodiment

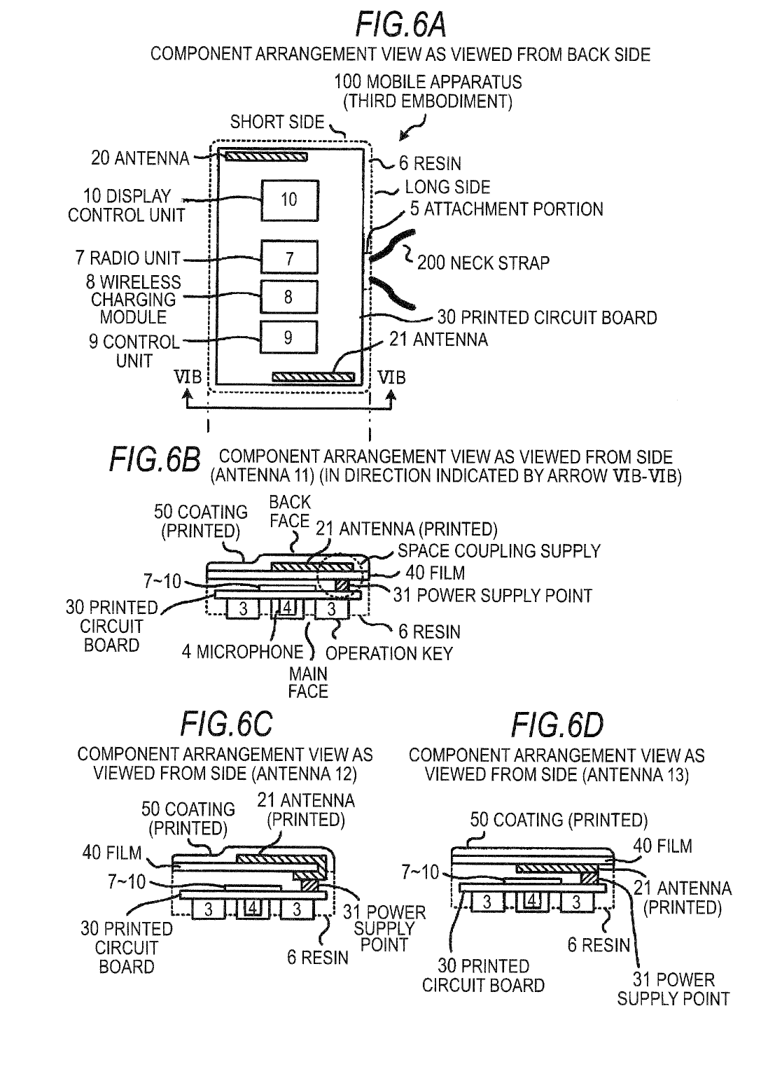

FIGS. 6A to 6D are partially transparent component arrangement view illustrating antenna arrangement of the mobile apparatus according to the third Embodiment. In the first Embodiment and the second Embodiment, the antennas are mounted on the printed circuit board 30. However, in the third Embodiment, to further separate the antennas from the human body, a film is provided on the back face portion, and the antennas are provided on the film. FIG. 6A is a component arrangement view as viewed from the back face side, FIG. 6B shows Antenna 11, and FIG. 6C shows Antenna 12, FIG. 6C shows Antenna 13. FIGS. 1A to 2C are common with the first Example, and the description thereof is omitted.

In FIG. 6A, the antenna 20 and the antenna 21 are provided in the vicinity of the short, sides, but the invention is not limited thereto. For example, they may be provided in the vicinity of the long sides as shown in Embodiment 1 and Embodiment 2.

(Antenna 11)

FIG. 6B is a component arrangement view as viewed from the side in a direction indicated by Arrow viB-viB shown in FIG. 6A. The printed circuit board 30 has a power supply point 31 for supplying power to the antenna. A film 40 is attached to the resin 6 on the back face of the printed circuit board 30. The antenna 21 has been already printed on the back face of the film 40 with plating or the like (antenna 20 is not shown). The visible user information is printed on the back face thereof by coating print or the like.

Power is supplied, from the power supply point 31 to the antenna 20 or the antenna 21 by space coupling supply using a floating capacitor.

(Antenna 12)

In FIG. 6C, the antenna 21 is printed by plating or the like from the back face of the film 40 through the film edge to the main face of the film (antenna 20 is not shown). The power supply point 31 has, for example, a sharp shape such as a pin shape, and is attached to the antenna 21 in a direct contact manner.

(Antenna 13)

In FIG. 6D, the antenna 21 has been already printed on the main face of the film 40 by plating or the like (antenna 20 is not shown). The power supply point 31 has, for example, a sharp shape such as a pin shape, and is attached to the antenna 21 in a direct contact manner.

According to the third Embodiment, the antennas can be further separated from the human body. When the mobile apparatus 100 is put on the human body, the antenna 20 and the antenna 21 are further separated from the human body. Therefore, it is possible to prevent deterioration in performance of the antennas.

The antenna is printed on the film by plating or the like. However, directly, a pattern is made using ink formed by mixing with catalyst on the resin 6, and the antenna may be formed in a film removing manner using the pattern.

The mobile apparatus 100 can be applied to a card type mobile phone, PHS, PDA, or the like. In addition, the invention can be applied to various cards having no operation key and display.

What is claimed is:

1. A mobile apparatus comprising:
a main face;
a back face opposite to the main face, the back face being printed with visible user information;
a thickness from the main face to the back face;
an antenna disposed at a position nearer the back face than the main face; and
an attachment portion attachable with a wearing tool, the wearing tool allowing a user to wear the mobile apparatus.

2. A mobile apparatus comprising:
a main body; and
a holder configured to receive the main body to allow a user to wear the main body, wherein:
the main body has: a main face, a back face opposite to the main face, the back face being printed with visible user information, a thickness from the main face to the back face, and an antenna disposed at a position nearer the back face than the main face; and
the holder is configured to allow the back face of the main body to be visible in a state where the main body is received in the holder.

3. A mobile apparatus comprising:
a main face;
a back face opposite to the main face, the back face being printed with visible user information;
a thickness from the main face to the back face;
an antenna disposed at a position nearer the back face than the main face; and
a user interface including operation keys disposed on the main face.

4. The mobile apparatus according to claim 3, further comprising:
a receiver; and
a transmitter, wherein:
the main face and the back face have substantially rectangular shapes, each including long sides and short sides;
a top of a printed section of the user information corresponds to one of the long sides, and a bottom of the printed section corresponds to the other of the long sides;
the receiver is provided at a position near one of the short sides in the main face; and
the transmitter is provided at a position near the other of the short sides in the main face.

5. The mobile apparatus according to claim 1, wherein:
the main face and the back face have substantially rectangular shapes, each including long sides and short sides; and
the antenna is disposed at a position near one of the short sides.

6. The mobile apparatus according to claim 2, wherein:
the main face and the back face have substantially rectangular shapes, each including long sides and short sides; and
the antenna is disposed at a position near one of the short sides.

7. The mobile apparatus according to claim 3, wherein:
the main face and the back face have substantially rectangular shapes, each including long sides and short sides; and
the antenna is disposed at a position near one of the short sides.

8. The mobile apparatus according to claim 1, wherein:
the main face and the back face have substantially rectangular shapes, each including long sides and short sides;
the antenna has a first antenna piece and a second antenna piece;
the first antenna piece is disposed at a position near one of the short sides;
the second antenna piece is disposed at a position near the other of the short sides; and
the first and the second antenna pieces are disposed diagonally.

9. The mobile apparatus according to claim 2, wherein:
the main face and the back face have substantially rectangular shapes, each including long sides and short sides;
the antenna has a first antenna piece and a second antenna piece;
the first antenna piece is disposed at a position near one of the short sides;
the second antenna piece is disposed at a position near the other of the short sides; and
the first and the second antenna pieces are disposed diagonally.

10. The mobile apparatus according to claim 3, wherein:
the main face and the back face have substantially rectangular shapes, each including long sides and short sides;
the antenna has a first antenna piece and a second antenna piece;
the first antenna piece is disposed at a position near one of the short sides;
the second antenna piece is disposed at a position near the other of the short sides; and
the first and the second antenna pieces are disposed diagonally.

11. The mobile apparatus according to claim 1, wherein:
the main face and the back face have substantially rectangular shapes, each including long sides and short sides; and
the antenna is an L-shaped plate having two faces being disposed to be parallel to a thickness direction and is disposed at a position near a corner.

12. The mobile apparatus according to claim 2, wherein:
the main face and the back face have substantially rectangular shapes, each including long sides and short sides; and
the antenna is an L-shaped plate having two faces being disposed to be parallel to a thickness direction and is disposed at a position near a corner.

13. The mobile apparatus according to claim 3, wherein:
the main face and the back face have substantially rectangular shapes, each including long sides and short sides; and
the antenna is an L-shaped plate having two faces being disposed to be parallel to a thickness direction and is disposed at a position near a corner.

14. The mobile apparatus according to claim 1, wherein:
the antenna has a first antenna piece and a second antenna piece;
the first antenna piece is disposed at a position nearer the back face than the main face; and
the other antenna piece is disposed at a position nearer the main face than the back face.

15. The mobile apparatus according to claim 2, wherein:
the antenna has a first antenna piece and a second antenna piece;
the first antenna piece is disposed at a position nearer the back face than the main face; and
the other antenna piece is disposed at a position nearer the main face than the back face.

16. The mobile apparatus according to claim 3, wherein:
the antenna has a first antenna piece and a second antenna piece;
the first antenna piece is disposed at a position nearer the back face than the main face; and
the other antenna piece is disposed at a position nearer the main face than the back face.

17. The mobile apparatus according to claim 1, wherein:
the main face and the back face have substantially rectangular shapes, each including long sides and short sides; and
the antenna is disposed at a position near the long side.

18. The mobile apparatus according to claim 2, wherein:
the main face and the back face have substantially rectangular shapes, each including long sides and short sides; and
the antenna is disposed at a position near the long side.

19. The mobile apparatus according to claim 3, wherein:
the main face and the back face have substantially rectangular shapes, each including long sides and short sides; and
the antenna is disposed at a position near the long side.

20. The mobile apparatus according to claim 1, further
comprising a printed circuit board, wherein the antenna is mounted on the printed circuit board on a face nearer the back face.

21. The mobile apparatus according to claim 2, further comprising a printed circuit board, wherein the antenna is mounted on the printed circuit board on a face nearer the back face.

22. The mobile apparatus according to claim 3, further comprising a printed circuit board, wherein the antenna is mounted on the printed circuit board on a face nearer the back face.

23. A mobile apparatus comprising:
a main face portion;
a back face portion;
a thickness from the main face portion to the back face portion;
an attachment portion attachable with a wearing tool, the wearing tool allowing a user to wear the mobile apparatus; and
a printed circuit board configured to supply power to an antenna in a space coupled manner or a contact coupled manner,
wherein the back face portion includes:
a film having the antenna formed by printing thereon, and
a coating print portion in which visible user information is printed on the film.

24. A mobile apparatus comprising:
a main face;
a back face opposite to the main face having a substantially rectangular shape including long sides and short sides;
a receiver; and
a transmitter, wherein:
visible user information is printed on the back face;
a top of a printed section of the user information corresponds to one of the long sides, and a bottom of the printed section corresponds to the other of the long sides;
the receiver is provided at a position near one of the short sides; and
the transmitter is provided at a position near the other of the short sides.

25. A mobile apparatus comprising:
a main face;
a back face;
an attachment portion attachable with a wearing tool, the wearing tool allowing a user to wear the mobile apparatus;
a receiver; and
a transmitter, wherein:
the mobile apparatus has a substantially rectangular shape including long sides and short sides;
visible user information is printed on the back face;
a top of a printed section of the user information corresponds to one of the long sides, and a bottom of the printed section corresponds to the other of the long sides;
the receiver is provided on the main face at a position near a right short side with respect to a direction from the bottom to the top of the printed section;
the transmitter is provided on the main face at a position near a left short side with respect to the direction from the bottom to the top of the printed section; and
the attachment portion is provided at a position near the top of the printed section.

26. A mobile apparatus comprising:
a main face;
a back face;
an attachment portion attachable with a wearing tool, the wearing tool allowing a user to wear the mobile apparatus;
a receiver; and
a transmitter, wherein:
the mobile apparatus has a substantially rectangular shape including long sides and short sides;
visible user information is printed on the back face;
a top of a printed section of the user information corresponds to one of the long sides, and a bottom of the printed section corresponds to the other of the long sides;
the receiver is provided on the main face at a position near a left short side with respect lo a direction from the bottom to the top of the printed section;
the transmitter is provided on the main face at a position near a right short side with respect to the direction from the bottom to the top of the printed section; and
the attachment portion is provided at a position near the top of the printed section.
